(19) United States
(12) Patent Application Publication
(10) Pub. No.: US 2012/0329980 A1
(43) Pub. Date: Dec. 27, 2012

(54) DiCHDM COPOLYESTERS

(75) Inventors: Scott Ellery George, Kingsport, TN (US); Joshua Seth Cannon, Greeneville, TN (US)

(73) Assignee: EASTMAN CHEMICAL COMPANY, Kingsport, TN (US)

(21) Appl. No.: 13/165,340

(22) Filed: Jun. 21, 2011

(51) Int. Cl. C08G 63/672

(52) U.S. Cl. 528/300

(57) ABSTRACT

This invention relates to a polymer comprising residues of at least one dicarboxylic acid and from about 0.5 mole % to about 100 mole % diCHDM residues, wherein the final polymer comprises substantially equal molar proportions of acid equivalents (100 mole %) and diol equivalents (100 mole %) for a total of 200 mole % for all reactants.

### FIELD OF THE INVENTION

A mixed by-product stream obtained from the purification of 1,4-cyclohexanedimethanol (CHDM) has been discovered to result in high molecular weight polyesters having properties in many cases similar to CHDM. This invention relates to high polymers based on diCHDM.

### BACKGROUND OF THE INVENTION

By-product formation affects the overall yield of chemical processes or reduces the quality of the final product. In the most desirable scenario, by-products are easily separated from the final product and directly recycled or least used for an alternate application. It is least desirable for by-products to represent no-value materials that must be incinerated or landfilled with the negative impact on yield, along with the additional cost of disposal.

### SUMMARY OF THE INVENTION

The polyesters of the present invention relate to the discovery that a mixture stream obtained during the synthesis of 1,4-cyclohexanedimethanol (CHDM) that can be used to synthesize high molecular weight copolyesters often having properties similar to CHDM-based compositions. In the broadest sense, novel compositions of matter are disclosed comprising:
residues of at least one dicarboxylic acid,
about 0.5 mole % to 100 mole % diCHDM residues,
optionally, residues of at least one additional diol,
optionally, residues of at least one multifunctional branching agent
containing at least three functional groups selected from hydroxyl, carboxyl, or a mixture thereof;
   the final polymer containing substantially equal molar proportions of acid equivalents (100 mole %) and diol equivalents (100 mole %) for a total of 200 mole % for all reactants wherein the inherent viscosity is at least 0.1 dl/g measured in a 60/40 parts by weight solution of phenol/tetrachloroethane at 25° C. and a concentration of 0.5 g of polymer in 100 ml of the solvent.

As summarized above, monomers employed for the synthesis of high molecular weight polyesters typically are discrete compositions having high purity. This allows for the attainment of desirable attributes, such as high molecular weight, low color, and predictable properties.

### DETAILED DESCRIPTION OF THE INVENTION

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. Typically the difunctional carboxylic acid can be a dicarboxylic acid and the difunctional hydroxyl compound can be a dihydric alcohol such as, for example, glycols and diols. The term “glycol” as used in this application includes, but is not limited to, diols, glycols, and/or multifunctional hydroxyl compounds, for example, branching agents. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a reaction process with a diol to make polyester. Furthermore, as used in this application, the term “diacid” includes multifunctional acids, for example, branching agents. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, or mixtures thereof or residues thereof useful in a reaction process with a diol to make polyester.

In one embodiment, terephthalic acid may be used as the starting material. In another embodiment, dimethyl terephthalate may be used as the starting material. In yet another embodiment, mixtures of terephthalic acid and dimethyl terephthalate may be used as the starting material and/or as an intermediate material.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % diCHDM, based on the total diol residues, means the polyester contains 30 mole % diCHDM residues out of a total of 100 mole % diol residues. Thus, there are 30 moles of diCHDM residues among every 100 moles of diol residues.

In one embodiment, compositions included within the scope of the invention are:
residues of at least one dicarboxylic acid,
about 0.5 mole % to 100 mole % diCHDM residues,
optionally, residues of at least one additional diol,
optionally, residues of at least one multifunctional branching agent containing at least three functional groups selected from hydroxyl, carboxyl, or a mixture thereof;
   the final polymer containing substantially equal molar proportions of acid equivalents (100 mole %) and diol equivalents (100 mole %) for a total of 200 mole % for all reactants wherein the inherent viscosity is at least 0.1 dl/g measured in a 60/40 parts by weight solution of phenol/tetrachloroethane at 25° C. and a concentration of 0.5 g of polymer in 100 ml of the solvent.

As a monomer, 1,4-cyclohexanedimethanol (CHDM) is known to provide high molecular weight copolyesters with high glass transition temperatures. During the synthesis of CHDM, by-products are formed that are typically removed as impurities for recycle or disposal. Two of these by-products are a high boiling fraction that contains a mixture of diCHDM ester and diCHDM ether in variable proportions. The term “diCHDM” as used herein includes both the ester and the ether, either present singly or in combination. Typically, impurities have a negative effect on polymer properties, but in the case of diCHDM there is little difference in glass transition and melting point at <50 mole % incorporation. At diCHDM levels above 50 mole % no difficulty was noted in achieving high molecular weights. A variety of compositions were demonstrated incorporating diCHDM, including PET fiber resins, adhesives, water-dispersible sulfopolyesters, and amorphous copolyesters. The diCHDM monomer is also useful to make other classes of condensation polymers, particularly polyurethanes.

During the synthesis of diols formation of ethers is a known side reaction that leads to undesired impurities. One of the most well known examples for comparison is ethylene glycol (EG) where dehydration reactions result in the formation of ethers. While diethylene glycol (DEG) is the primary by-product, other higher order homologs, such as triethylene glycol (TEG), quatraethylene glycol (QEG), and so forth are also obtained. The presence of DEG alone has a deleterious effect on EG-based polyesters, particularly decreased T_{glass} and increased color. Higher order homologs have an even greater negative effect on T_{glass} and color. In the case of polyethylene terephthalate (PET) considerable efforts have been made to minimize DEG content for container applications. An important note is that ethers can be formed during both the monomer and polymer syntheses.

The generic structure of 1,4-CHDM is shown in FIG. 1 and like EG, ether formation will occur as a side reaction during the monomer synthesis, a process that is based on the reduction of dimethyl terephthalate (DMT) with hydrogen. Unlike the synthesis of EG that is normally accomplished via the oxidation of ethylene to ethylene oxide and followed by hydration, the CHDM reaction sequence also allows for a by-product having an internal ester linkage.

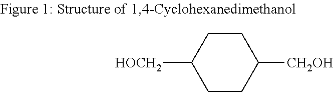

Both of these by-products, as shown in FIG. 2, are formed during the synthesis of CHDM and are removed from the polymer grade monomer as a high boiling mixture.

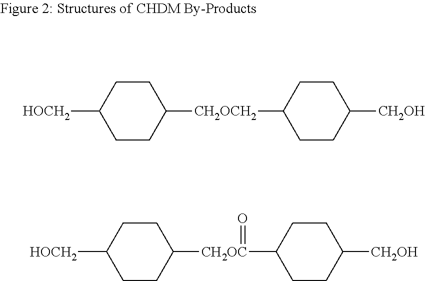

Similar to the comparative example of EG, the by-product stream is highly difunctional and thus does not decrease the attainment of high molecular weights during polyester synthesis. Unlike EG, higher order homologues are not observed for CHDM in appreciable quantities. From a practical perspective diCHDM can be considered a pure mixture monomer. The proportion of diCHDM ether to diCHDM ester can vary and all possible proportions are useful. Therefore, each component can vary from 0 to 100 wt % of the total mixture. About a 50:50 mixture is commonly used, but is not necessarily preferred. Each component is useful alone for the synthesis of polyesters and pure compounds of diCHDM ether and diCHDM ester are also within the scope of this invention. One or both of diCHDM ether and diCHDM ester may be used to replace any portion of CHDM in any polymer known in the art that comprises CHDM. Each ring of each component can also exist as the cis or trans geometric isomer leading to a large number of compositional combinations that are all useful. In one embodiment, diCHDM may be used in polyesters known in the art to contain CHDM.

In other aspects of the invention, the glycol component for the polyesters useful in the invention include but are not limited to at least one of the following combinations of ranges: 1 to 99 mole % diCHDM; 5 to 99 mole % diCHDM; 10 to 99 mole % diCHDM; 15 to 99 mole % diCHDM; 20 to 99 mole % diCHDM, 25 to 99 mole % diCHDM; 30 to 99 mole % diCHDM; 35 to 99 mole % diCHDM; 40 to 99 mole % diCHDM; 45 to 99 mole % diCHDM; 50 to 99 mole % diCHDM; 55 to 99 mole % diCHDM; 60 to 99 mole % diCHDM; 65 to 99 mole % diCHDM; 70 to 99 mole % diCHDM; 75 to 99 mole % diCHDM; 80 to 99 mole % diCHDM; 85 to 99 mole % diCHDM; 90 to 99 mole % diCHDM; and 95 to 99 mole % diCHDM; 90 to less than 99.95 mole % diCHDM; or 95 to less than 99.99 mole % diCHDM.

In other aspects of the invention, the glycol component for the polyesters useful in the invention include but are not limited to at least one of the following combinations of ranges: 1 to 95 mole % diCHDM; 5 to 95 mole % diCHDM; 10 to 95 mole % diCHDM; 15 to 95 mole % diCHDM; 20 to 95 mole % diCHDM, 25 to 95 mole % diCHDM; 30 to 95 mole % diCHDM; 35 to 95 mole % diCHDM; 40 to 95 mole % diCHDM 45 to 95 mole % diCHDM; or 50 to 95 mole % diCHDM.

In other aspects of the invention, the glycol component for the polyesters useful in the invention include but are not limited to at least one of the following combinations of ranges:

In other aspects of the invention, the glycol component for the polyesters useful in the film or sheet of the invention include but are not limited to at least one of the following combinations of ranges: 1 to 90 mole % diCHDM; 5 to 90 mole % diCHDM; 10 to 90 mole % diCHDM; 15 to 90 mole % diCHDM; 20 to 90 mole % diCHDM, 25 to 90 mole % diCHDM; 30 to 90 mole % diCHDM; 35 to 90 mole % diCHDM; 40 to 90 mole % diCHDM; 45 to 90 mole % diCHDM; and 50 to 90 mole % diCHDM.

In other aspects of the invention, the glycol component for the polyesters useful in the invention include but are not limited to at least one of the following combinations of ranges: 1 to 85 mole % diCHDM; 5 to 85 mole % diCHDM; 10 to 85 mole % diCHDM; 15 to 85 mole % diCHDM; 15 to 85 mole % diCHDM, 25 to 85 mole % diCHDM; 30 to 85 mole % diCHDM; 35 to 85 mole % diCHDM; 40 to 85 mole % diCHDM; 45 to 85 mole % diCHDM; 50 to 85 mole % diCHDM; 55 to 85 mole % diCHDM; 60 to 85 mole % diCHDM; 65 to 85 mole % diCHDM; 70 to 85 mole % diCHDM; 75 to 85 mole % diCHDM; and 80 to 85 mole % diCHDM.

In other aspects of the invention, the glycol component for the polyesters useful in the invention include but are not limited to at least one of the following combinations of ranges: 1 to 80 mole % diCHDM; 5 to 80 mole % diCHDM; 10 to 80 mole % diCHDM; 15 to 80 mole % diCHDM; 20 to 80 mole % diCHDM, 25 to 80 mole % diCHDM; 30 to 80 mole % diCHDM; 35 to 80 mole % diCHDM; 40 to 80 mole % diCHDM; 45 to 80 mole % diCHDM; 50 to 80 mole % diCHDM; 55 to 80 mole % diCHDM; 60 to 80 mole % diCHDM; 65 to 80 mole % diCHDM; 70 to 80 mole % diCHDM; and 75 to 80 mole % diCHDM.

In other aspects of the invention, the glycol component for the polyesters useful in the invention include but are not limited to at least one of the following combinations of ranges: 1 to 75 mole % diCHDM; 10 to 75 mole % diCHDM; 15 to 75 mole % diCHDM; 20 to 75 mole % diCHDM, 25 to 75 mole % diCHDM; 30 to 75 mole % diCHDM; 35 to 75 mole % diCHDM; 40 to 75 mole % diCHDM; 45 to 75 mole % diCHDM; 50 to 75 mole % diCHDM; 55 to 75 mole % diCHDM; 60 to 75 mole % diCHDM; 65 to 75 mole % diCHDM; and 70 to 75 mole % diCHDM.

In other aspects of the invention, the glycol component for the polyesters useful in the invention include but are not limited to at least one of the following combinations of ranges: 20 to 65 mole % diCHDM; 20 to 60 mole % diCHDM; 20 to 55 mole % diCHDM; 20 to 50 mole % diCHDM; 20 to less than 50 mole % diCHDM; 20 to 45 mole % diCHDM; 20 to 40 mole % diCHDM; 20 to 35 mole % diCHDM; 20 to 30 mole % diCHDM; 25 to 60 mole % diCHDM; 25 to 55 mole % diCHDM; 25 to 50 mole % diCHDM; 25 to 45 mole % diCHDM; 25 to 40 mole % diCHDM; 25 to 35 mole % diCHDM; 30 to 60 mole % diCHDM; 30 to 55 mole % diCHDM; 30 to 50 mole % diCHDM 1 to less than 50 mole % diCHDM; 20 to less than 50 mole % diCHDM; 25 to less than 50 mole % diCHDM; 30 to less than 50 mole % diCHDM; 30 to 45 mole % diCHDM; 30 to 40 mole % diCHDM; 35 to 60 mole % diCHDM; 45 to 60 mole % diCHDM; 35 to 55 mole % diCHDM; 35 to less than 50 mole % diCHDM.; 35 to 50 mole % diCHDM; 35 to 45 mole % diCHDM; 40 to 60 mole % diCHDM; 40 to 55 mole % diCHDM; and 45 to 55 mole % diCHDM. In combination with any of these ranges, one or more additional glycols may be present. In one embodiment, one additional glycol is present and is ethylene glycol. In one embodiment, one additional glycol is present and is 2,2,4,4-tetramethyl-1,3-cyclobutanediol. In another embodiment, two additional glycols are present and are ethylene glycol and 2,2,4,4-tetramethyl-1,3-cyclobutanediol.

In certain embodiments, terephthalic acid, or an ester thereof, such as, for example, dimethyl terephthalate, or a mixture of terephthalic acid and an ester thereof, makes up most or all of the dicarboxylic acid component used to form the polyesters useful in the invention. In certain embodiments, terephthalic acid residues can make up a portion or all of the dicarboxylic acid component used to form the present polyester. In one embodiment, terephthalic acid or an ester thereof comprises at least 80 mole %, at least 90 mole %, at least 95 mole %, at least 99 mole %, or 100 mole % of the dicarboxylic acid residues. For purposes of this disclosure, the terms “terephthalic acid” and “dimethyl terephthalate are used interchangeably herein. In one embodiment, dimethyl terephthalate is part or all of the dicarboxylic acid component used to make the polyesters useful in the present invention. In all embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acid residues, the dicarboxylic acid component of the polyesters useful in the invention can comprise one or more modifying aromatic dicarboxylic acids. Yet another embodiment contains 0 mole % modifying aromatic dicarboxylic acids. In one embodiment, modifying dicarboxylic acids may comprises up to 30 mole %, up to 20 mole %, up to 10 mole %, up to 5 mole %, or up to 1 mole % of total acid component of the polyester. Thus, if present, it is contemplated that the amount of one or more modifying aromatic dicarboxylic acids can range from any of these preceding endpoint values including, for example, from 0.01 to 30 mole %, from 0.01 to 20 mole %, from 0.01 to 10 mole %, from 0.01 to 5 mole %, or from 0.01 to 1 mole % of one or more modifying aromatic dicarboxylic acids. In one embodiment, modifying aromatic dicarboxylic acids that may be used in the present invention include but are not limited to .those having up to 20 carbon atoms, and that can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-napththalenedicarboxylic acid, and trans-4,4′-stilbenedicarboxylic acid, and esters thereof. In one embodiment, isophthalic acid is the modifying aromatic dicarboxylic acid.

The carboxylic acid component of the polyesters useful in the invention can be further modified with up to 10 mole %, such as up to 5 mole % or up to 1 mole % of one or more aliphatic dicarboxylic acids containing 2-16 carbon atoms, such as, for example, malonic, succinic, glutaric, adipic, pimelic, suberic, azelaic and dodecanedioic dicarboxylic acids. Certain embodiments can also comprise 0.01 or more mole %, such as 0.1 or more mole %, 1 or more mole %, 5 or more mole %, or 10 or more mole % of one or more modifying aliphatic dicarboxylic acids. Yet another embodiment contains 0 mole % modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

It is to be understood that the term “dicarboxylic acid” includes the use of the corresponding esters, acid anhydrides, and acid chlorides with free acids (—COON) and esters being preferred.

In one embodiment, examples of preferred diols for suitable polymers include ethylene glycol; diethylene glycol; triethylene glycol; quatraethylene glycol (QEG); neopentyl glycol; 1,2-propanediol; 1,3-propanediol; 2-ethyl-2-butyl-1,3-propanediol; 1,3-butanediol; 1,4-butanediol; 1,5-pentanediol; 1,6-hexanediol; 1,3-cyclohexanedimethanol; 1,4-cyclohexanedimethanol; 2,2,4,4-tetramethyl-1,3-cyclobutanediol and p-xylylenediol. Copolyesters may be advantageously prepared from two or more of the above diols. As discussed above, it is known that DEG, TEG, and QEG may be formed in situ due to side reactions that result from the process conditions where the acid catalyzed dehydration of ethylene glycol (EG) occurs with EG, EG with DEG, and so forth to yield DEG, TEG, and QEG. Additional examples of alkyl ether diols include higher order species, such as dipropylene glycol, tripropylene glycol, dibutylene glycol, and ethylene propylene glycol. Preferred diols due to availability, cost, and utility include ethylene glycol; neopentyl glycol; 1,4-butanediol; 1,6-hexanediol; 1,4-cyclohexanedimethanol and 2,2,4,4-tetramethyl-1,3-cyclobutanediol.

Additional suitable diols may be selected from oligomeric and polymeric species, such as hydroxyl-terminated polyethers varying in number average molecular weight from about 200 to 20,000 g/mole with 200 to 5000 g/mole comprising a preferred molecular weight range. Representative examples from this class of diols include polyethylene glycols, available commercially under the Carbowax™ designation, a product of Dow Chemical Company, and higher order polyalkylene ethers, such as polypropylene glycol and polytetramethylene ether glycol known by the trade name TERATHANE™, a product of Invista, Inc. It is also possible to have more than one monomer unit within a polyether diol to provide a random copolymer of any proportion; the SYNALOX™ (a product of Dow Chemical Company) ethylene oxide/propylene oxide copolymers are a commercially available example. Another embodiment is to have block structures with an example being the UCON™ ethylene oxide-b-propylene oxide products from Dow Chemical Company. For applications where clarity is not generally a requirement, hydroxyl-terminated polybutadienes and their hydrogenated derivatives may be used, available commercially under the Krasol™ designation, a product of Cray Valley.

The multifunctional branching agents contain at least three functional groups selected from hydroxyl and carboxyl moieties. In certain embodiments, suitable multifunctional reactants can include at least one of trimethylol propane (TMP), trimethylolethane (TME), glycerin, pentaerythritol, erythritol, threitol, dipentaerythritol, sorbitol, trimellitic anhydride (TMA), trimesic acid, pyromellitic dianhydride and dimethylol propionic acid.

Certain reactants, selected from either dicarboxylic acids or diols, are useful for imparting specific properties. Unsaturated reactants allow for post-polymerization chemistries such as functionalization reactions or free-radical curing of film substrates. Useful unsaturated reactants include maleic anhydride, fumaric acid, stilbenedicarboxylic acid and itaconic acid.

In one embodiment, diCHDM can be used to make water-dispersible polyesters known in the art where at least one sulfomonomer is used having the preferred general structure illustrated in FIG. 3.

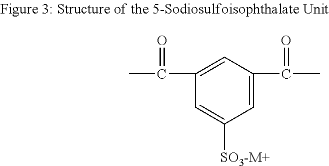

The term sulfodiacid includes the dicarboxylic acid or the ester thereof and in some cases it is advantageous to pre-react the diacid or diester with at least one glycol to form an intermediate before synthesis of the final polymer. The counterion, M+, may be a metal cation, such as Li+, Na+, K+, Ca++, Mg++, Cu++, and the like. Group 1 alkali metals are most preferred since they are most amenable to melt phase polyester synthesis, but other metal cations can be obtained by ion exchange of the polymer as well as nitrogen-based counterions. Another alternative is to employ a phosphonium counterion that is known to be tolerant of a melt phase polyester process and yields a sulfopolyester having a lesser degree of water sensitivity.

The polyesters disclosed herein are not limited with regard to molecular weight. Practical limitations do exist for both low and high molecular weights, where an inherent viscosity, measured in a 60/40 parts by weight solution of phenol/tetrachloroethane at 25° C. and at a concentration of about 0.5 g of polymer in 100 mL of said solvent, of at least 0.1 dL/g is required for minimal polymer physical properties. On the upper end, although it is possible to conduct polyester synthesis in diluted solutions of organic solvents or using interfacial techniques, these are much less preferred compared to melt phase polymerization where melt viscosity typically limits molecular weight to an IhV of less than 1.5 dL/g. Preferred ranges will be dependent on the specific application. For example, hot melt adhesives and polyols may be nearer to the lower end of the stated IhV limits and elastomers may be nearer to the upper end.

For certain embodiments of the invention, the polyesters useful in the invention may exhibit at least one of the following inherent viscosities as determined in 60/40 (wt/wt) phenol/ tetrachloroethane at a concentration of 0.5 g/100 ml at 25° C.: 0.10 to 1.2 dL/g; 0.10 to 1.1 dL/g; 0.10 to 1 dL/g; ; 0.10 to less than 1 dL/g; 0.10 to 0.98 dL/g; 0.10 to 0.95 dL/g; 0.10 to 0.90 dL/g; 0.10 to 0.85 dL/g; 0.10 to 0.80 dL/g; 0.10 to 0.75 dL/g; 0.10 to less than 0.75 dL/g; 0.10 to 0.72 dL/g; 0.10 to 0.70 dL/g; 0.10 to less than 0.70 dL/g; 0.10 to 0.68 dL/g; 0.10 to less than 0.68 dL/g; 0.10 to 0.65 dL/g; 0.20 to 1.2 dL/g; 0.20 to 1.1 dL/g; 0.20 to 1 dL/g; 0.20 to less than 1 dL/g; 0.20 to 0.98 dL/g; 0.20 to 0.95 dL/g; 0.20 to 0.90 dL/g; 0.20 to 0.85 dL/g; 0.20 to 0.80 dL/g; 0.20 to 0.75 dL/g; 0.20 to less than 0.75 dL/g; 0.20 to 0.72 dL/g; 0.20 to 0.70 dL/g; 0.20 to less than 0.70 dL/g; 0.20 to 0.68 dL/g; 0.20 to less than 0.68 dL/g; 0.20 to 0.65 dL/g; 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; greater than 0.42 to 1.2 dL/g; greater than 0.42 to 1.1 dL/g; greater than 0.42 to 1 dL/g; greater than 0.42 to less than 1 dL/g; greater than 0.42 to 0.98 dL/g; greater than 0.42 to 0.95 dL/g; greater than 0.42 to 0.90 dL/g; greater than 0.42 to 0.85 dL/g; greater than 0.42 to 0.80 dL/g; greater than 0.42 to 0.75 dL/g; greater than 0.42 to less than 0.75 dL/g; greater than 0.42 to 0.72 dL/g; greater than 0.42 to less than 0.70 dL/g; greater than 0.42 to 0.68 dL/g; greater than 0.42 to less than 0.68 dL/g; and greater than 0.42 to 0.65 dL/g.

For certain embodiments of the invention, the polyesters useful in the invention may exhibit at least one of the following inherent viscosities as determined in 60/40 (wt/wt) phenol/ tetrachloroethane at a concentration of 0.5 g/100 ml at 25° C.: 0.45 to 1.2 dL/g; 0.45 to 1.1 dL/g; 0.45 to 1 dL/g; 0.45 to 0.98 dL/g; 0.45 to 0.95 dL/g; 0.45 to 0.90 dL/g; 0.45 to 0.85 dL/g; 0.45 to 0.80 dL/g; 0.45 to 0.75 dL/g; 0.45 to less than 0.75 dL/g; 0.45 to 0.72 dL/g; 0.45 to 0.70 dL/g; 0.45 to less than 0.70 dL/g; 0.45 to 0.68 dL/g; 0.45 to less than 0.68 dL/g; 0.45 to 0.65 dL/g; 0.50 to 1.2 dL/g; 0.50 to 1.1 dL/g; 0.50 to 1 dL/g; 0.50 to less than 1 dL/g; 0.50 to 0.98 dL/g; 0.50 to 0.95 dL/g; 0.50 to 0.90 dL/g; 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; 0.55 to 1.2 dL/g; 0.55 to 1.1 dL/g; 0.55 to 1 dL/g; 0.55 to less than 1 dL/g; 0.55 to 0.98 dL/g; 0.55 to 0.95 dL/g; 0.55 to 0.90 dL/g; 0.55 to 0.85 dL/g; 0.55 to 0.80 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.65 dL/g; 0.58 to 1.2 dL/g; 0.58 to 1.1 dL/g; 0.58 to 1 dL/g; 0.58 to less than 1 dL/g; 0.58 to 0.98 dL/g; 0.58 to 0.95 dL/g; 0.58 to 0.90 dL/g; 0.58 to 0.85 dL/g; 0.58 to 0.80 dL/g; 0.58 to 0.75 dL/g; 0.58 to less than 0.75 dL/g; 0.58 to 0.72 dL/g; 0.58 to 0.70 dL/g; 0.58 to less than 0.70 dL/g; 0.58 to 0.68 dL/g; 0.58 to less than 0.68 dL/g; 0.58 to 0.65 dL/g; 0.60 to 1.2 dL/g; 0.60 to 1.1 dL/g; 0.60 to 1 dL/g; 0.60 to less than 1 dL/g; 0.60 to 0.98 dL/g; 0.60 to 0.95 dL/g; 0.60 to 0.90 dL/g; 0.60 to 0.85 dL/g; 0.60 to 0.80 dL/g; 0.60 to 0.75 dL/g; 0.60 to less than 0.75 dL/g; 0.60 to 0.72 dL/g; 0.60 to 0.70 dL/g; 0.60 to less than 0.70 dL/g; 0.60 to 0.68 dL/g; 0.60 to less than 0.68 dL/g; 0.60 to 0.65 dL/g; 0.65 to 1.2 dL/g; 0.65 to 1.1 dL/g; 0.65 to 1 dL/g; 0.65 to less than 1 dL/g; 0.65 to 0.98 dL/g; 0.65 to 0.95 dL/g; 0.65 to 0.90 dL/g; 0.65 to 0.85 dL/g; 0.65 to 0.80 dL/g; 0.65 to 0.75 dL/g; 0.65 to less than 0.75 dL/g; 0.65 to 0.72 dL/g; 0.65 to 0.70 dL/g; 0.65 to less than 0.70 dL/g; 0.68 to 1.2 dL/g; 0.68 to 1.1 dL/g; 0.68 to 1 dL/g; 0.68 to less than 1 dL/g; 0.68 to 0.98 dL/g; 0.68 to 0.95 dL/g; 0.68 to 0.90 dL/g; 0.68 to 0.85 dL/g; 0.68 to 0.80 dL/g; 0.68 to 0.75 dL/g; 0.68 to less than 0.75 dL/g; 0.68 to 0.72 dL/g; greater than 0.76 dL/g to 1.2 dL/g; greater than 0.76 dL/g to 1.1 dL/g; greater than 0.76 dL/g to 1 dL/g; greater than 0.76 dL/g to less than 1 dL/g; greater than 0.76 dL/g to 0.98dL/g; greater than 0.76 dL/g to 0.95 dL/g; greater than 0.76 dL/g to 0.90 dL/g; greater than 0.80 dL/g to 1.2 dL/g; greater than 0.80 dL/g to 1.1 dL/g; greater than 0.80 dL/g to 1 dL/g; greater than 0.80 dL/g to less than 1 dL/g; greater than 0.80 dL/g to 1.2 dL/g; greater than 0.80 dL/g to 0.98dL/g; greater than 0.80 dL/g to 0.95 dL/g; greater than 0.80 dL/g to 0.90 dL/g.

The preferred Tg of the polyesters will be defined by the applications to those skilled in the art and is not a limitation for the present invention. As an illustrative example, an adhesive polyester would advantageously have a T_{g}<0° C. as compared to a heavy gauge sheet for outdoor signage where a T_{g}>100° C. would be preferred.

Blends with other polymers are included within the scope of this invention, particularly additional polyesters, polyamides, polycarbonates, and polyurethanes. Compatiblized blends with functionalized polyolefins are anticipated as well.

In addition, the polyester compositions and the polymer blend compositions containing the polyesters useful in this invention may also contain, for example, from 0.01 to 25% by weight or 0.01 to 20% by weight or 0.01 to 15% by weight or 0.01 to 10% by weight or 0.01 to 5% by weight of the total weight of the polyester composition of common additives such as colorants, dyes, mold release agents, nucleating agents, flame retardants, plasticizers, nucleating agents, stabilizers, including but not limited to, UV stabilizers, thermal stabilizers and/or reaction products thereof, fillers, and impact modifiers. Examples of typical commercially available impact modifiers well known in the art and useful in this invention include, but are not limited to, ethylene/propylene terpolymers; functionalized polyolefins, such as those containing methyl acrylate and/or glycidyl methacrylate; styrene-based block copolymeric impact modifiers; and various acrylic core/shell type impact modifiers. For example, UV additives can be incorporated into articles of manufacture through addition to the bulk, through application of a hard coat, or through coextrusion of a cap layer. Residues of such additives are also contemplated as part of the polyester composition.

The polyesters of the invention can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, preferably about 0.1 to about 5 percent by weight, based on the total weight of the polyester.

Thermal stabilizers are compounds that stabilize polyesters during polyester manufacture and/or post polymerization including, but not limited to, phosphorous compounds including but not limited to phosphoric acid, phosphorous acid, phosphonic acid, phosphinic acid, phosphonous acid, and various esters and salts thereof. These can be present in the polyester compositions useful in the invention. The esters can be alkyl, branched alkyl, substituted alkyl, difunctional alkyl, alkyl ethers, aryl, and substituted aryl. In one embodiment, the number of ester groups present in the particular phosphorous compound can vary from zero up to the maximum allowable based on the number of hydroxyl groups present on the thermal stabilizer used. The term “thermal stabilizer” is intended to include the reaction products thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive.

Reinforcing materials may be useful in the compositions of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials are glass, such as, fibrous glass filaments, mixtures of glass and talc, glass and mica, and glass and polymeric fibers.

In another embodiment, the invention further relates to articles of manufacture comprising any of the polyesters and blends described above

The processes known for preparing polyesters of the invention involve an ester-interchange or esterification stage followed by a polycondensation stage. Preferably, polyester synthesis is performed as a melt phase process in the absence of organic solvents. The ester-interchange or esterification is conducted under an inert atmosphere at a temperature of 150° to 260° C. for 0.5 to 8 hours, preferably from 180° C. to 240° C. for 1 to 4 hours. The diols, including diCHDM, vary in reactivity with dependency on the process conditions employed, but are commonly used in molar excesses of 1.05 to 3 moles per total moles of acid functional monomers. The polycondensation stage is advantageously performed under reduced pressure at a temperature of 220° C. to 350° C., preferably 240° C. to 300° C., and more preferably 250° to 290° C. for 0.1 to 6 hours, preferably from 0.5 to 3 hours. Stirring or appropriate conditions are used in both stages to ensure adequate heat transfer and surface renewal of the reaction mixture. The reactions of both stages are facilitated by the judicious selection of catalysts known in the art, including but not limited to alkyl and alkoxy titanium compounds, alkali metal hydroxides and alkoxides, organotin compounds, germanium oxide, organogermanium compounds, aluminum compounds, manganese salts, zinc salts, rare earth compounds, antimony oxide, and so forth. Protonic acids can also find utility as catalysts, particularly in the self catalyzed esterification of dicarboxylic acids with glycols. Phosphorous compounds may be used as stabilizers to control color and reactivity of residual catalysts. Typical examples are phosphoric acid, phosphonic acid, and phosphate esters, such as Merpol™ A, a product of Stepan Chemical Company.

In another embodiment, polyurethanes may also be prepared using diCHDM. Polyurethanes are another common class of condensation polymers where diols, polyols, and hydroxyl-terminated polyester can all be reacted with diisocyanates. The use of polyester polyols was disclosed many years ago in U.S. Pat. No. 2,621,166 and prior art specifically relating the polyurethanes containing 1,4-CHDM as a chain extender or within a hydroxyl-terminated polyester is the subject of U.S. Pat. No. 4,284,750. Thus, while there is no disclosure around the use of diCHDM as a diol in polyurethane synthesis, it does have the characteristics of 1,4-CHDM and is within the scope of this invention. All of the diols and polyols disclosed supra are useful for polyurethane synthesis via reaction with a diisocyanate. Useful diisocyanates include methylene bis diphenyl diisocyanate (MDI), isomers of toluene diisocyanate (TDI), polyphenyl polymethylene polyisocyanates (PMDI), 1,6-hexamethylene diisocyanates, isophorone diisocyanate (IPDI), isomers of dicyclohexylmethanediisocyanate, substituted xylene diisocyanates, and combinations of diisocyanates. Modified diisocyanate compounds containing ester, urea, biuret, allophanate, crbodiimide, isocyanurate, and uretoimines are contemplated as well. Catalysts known in the art for polyurethanes are useful for the reaction of diCHDM or diCHDM polyesters with diisocyanates and include a variety of compounds, such as alkyl titanates, alkoxy titanates, tin halides, and organotins. Preferred organotin compounds include dibutyl tin dilaurate, dibutyl tin oxide, butyl tin tri-2-ethylhexanoate, and stannous octoate that are supplied commercially by Arkema under the Fascat™ tradename. If a polyester polyol is used, it may be possible to employ the same catalyst for the synthesis of the polyester and subsequent synthesis of the polyurethane.

All of the known polyurethane applications may advantageously use diCHDM. These applications include molding materials, coatings, adhesives, and foams. Coatings and adhesives include, but are not limited to 2K solventborne systems, 1K solvent or waterborne formulations, hot melt, and aqueous PUDs. Foams may be flexible or rigid based on appropriate selection of comonomers. Molding plastics include both thermoplastics and thermosets.

This invention can be further illustrated by the following examples of preferred embodiments thereof, although it will be understood that these examples are included merely for purposes of illustration and are not intended to limit the scope of the invention unless otherwise specifically indicated.

### EXAMPLES

### 1. General Synthesis Example to Obtain a High Molecular Weight Amorphous Polyester

A 500 mL round bottom flask equipped with a ground glass head, agitator shaft, nitrogen inlet, and a sidearm to allow for removal of volatile materials was charged with 97 grams (0.50 moles) dimethyl terephthalate, 57.1 grams (0.92 moles) ethylene glycol, 22 grams (0.08 moles) diCHDM, and 0.86 mL of a 0.985% (w/v) solution of titan ium(IV)isopropoxide in n-butanol. The flask was purged 2× with nitrogen and immersed in a Belmont metal bath at 200° C. for 60 minutes and 210° C. for an additional 60 minutes under a slow nitrogen sweep with agitation. After increasing the temperature to 280° C., a vacuum of <1mm was attained and held for 50 minutes to complete the polycondensation. The vacuum was displaced with nitrogen and the clear polymer was allowed to cool before removal from the flask. An inherent viscosity of 0.82 was obtained for the recovered polymer according to ASTM D3835-79 at a concentration of 0.5 g/100 mL solvent. NMR analysis indicated that the actual glycol composition was 84 mole % ethylene glycol and 16 mole % diCHDM. Thermal analysis by DSC yielded a glass transition temperature (T_{g}) of 75° C.; a melting point (Tₘ) was not detected.

PET for fibers is typically obtained in a melt phase only process where an IhV of <0.65 is adequate for physical property requirements. A small amount of a second diacid or diol is added to decrease the rate of crystallization. Examples 2 and 3 show that diCHDM is essentially equivalent to CHDM as a modifier for PET with effect on T_{g} and melting point.

2. Fiber Grade PET with diCHDM Comonomer

The apparatus described in Example 1 was charged with 97 grams (0.50 moles) dimethyl terephthalate, 62 grams (1.0 moles) ethylene glycol, 2.5 grams (0.009 moles) diCHDM, 0.70 mL of a 1.05% (w/v) solution of titanium(IV)isopropoxide in n-butanol, 1.04 mL of a 0.52% (w/v) solution of manganese acetate in ethylene glycol, 1.45 mL of a 0.54% (w/v) solution of cobalt acetate in ethylene glycol, and 7.3 mL of a 0.31% solution of antimony trioxide in ethylene glycol. The flask was purged 2× with nitrogen and immersed in a Belmont metal bath at 200° C. for 60 minutes and 210° C. for an additional 60 minutes under a slow nitrogen sweep with agitation. At this point 1.11 mL of Merpol™ A phosphorous stabilizer were added to the flask. After increasing the temperature to 265° C., a vacuum of 0.5 mm was attained and held for 63 minutes to complete the polycondensation. The vacuum was displaced with nitrogen and the clear, slightly grey polymer melt was allowed to cool and rapidly crystallize to a white, opaque solid before removal from the flask. An inherent viscosity of 0.68 was obtained for the recovered polymer according to ASTM D3835-79 at a concentration of 0.5 g/100 mL solvent. NMR analysis indicated that the actual glycol composition was 96.5 mole % EG, 2.1 mole % diCHDM, and 1.4 mole % DEG. Thermal analysis by DSC yielded a 2^{nd} cycle glass transition temperature (T_{g}) of 82° C. and a 1^{st} cycle melting point (Tₘ) of 244° C.

3. (Comparative) Fiber Grade PET with CHDM Comonomer

The apparatus described in Example 1 was charged with 97 grams (0.50 moles) dimethyl terephthalate, 62 grams (1.0 moles) ethylene glycol, 1.2 grams (0.008 moles) diCHDM, 0.69 mL of a 1.05% (w/v) solution of titanium(IV)isopropoxide in n-butanol, 1.02 mL of a 0.52% (w/v) solution of manganese acetate in ethylene glycol, 1.43 mL of a 0.54% (w/v) solution of cobalt acetate in ethylene glycol, and 7.2 mL of a 0.31% solution of antimony trioxide in ethylene glycol. The flask was purged 2× with nitrogen and immersed in a Belmont metal bath at 200° C. for 60 minutes and 210° C. for an additional 60 minutes under a slow nitrogen sweep with agitation. At this point 1.09 mL of Merpol™ A phosphorous stabilizer were added. After increasing the temperature to 265° C., a vacuum of 0.5 mm was attained and held for 73 minutes to complete the polycondensation. The vacuum was displaced with nitrogen and the clear, grayish polymer melt was allowed to cool and rapidly crystallize to a white, opaque solid before removal from the flask. An inherent viscosity of 0.72 was obtained for the recovered polymer according to ASTM D3835-79 at a concentration of 0.5 g/100 mL solvent. NMR analysis indicated that the actual glycol composition was 96.8 mole % EG, 1.6 mole % CHDM, and 1.6 mole % DEG. Thermal analysis by DSC yielded a 2^{nd} cycle glass transition temperature (T_{g}) of 82° C. and a 1^{st} cycle melting point Tₘ of 246° C.

### Example 4

### Shows that a Polyester can be Synthesized using diCHDM as the only Diol

4. Copolyester Containing diCHDM as the Only Diol

The apparatus described in Example 1 was charged with 97 grams (0.50 moles) dimethyl terephthalate, 141.9 grams (0.53 mole) diCHDM, and 1.53 mL of a 0.98% (w/v) solution of titan ium(IV)isopropoxide in n-butanol. The flask was purged 2× with nitrogen and immersed in a Belmont metal bath at 240° C. for 60 minutes under a slow nitrogen sweep with agitation. After increasing the temperature to 270° C., a vacuum of 0.3 mm was attained and held for 61 minutes to complete the polycondensation. The vacuum was displaced with nitrogen and the clear, amber polymer melt was allowed to cool before removal from the flask. An inherent viscosity of 0.28 was obtained for the recovered polymer according to ASTM D3835-79 at a concentration of 0.5 g/100 mL solvent. Thermal analysis by DSC yielded a 2^{nd} cycle glass transition temperature (T_{g}) of 51° C.

### Example 5

### Illustrates that a High Molecular Weight Copolyester can be Obtained with a High Level of diCHDM

5. Amorphous Copolyester with 80% diCHDM

The apparatus described in Example 1 was charged with 97 grams (0.50 moles) dimethyl terephthalate, 33 grams (0.53 moles) ethylene glycol, 108 grams (0.40 moles) diCHDM, and 1.37 mL of a 0.98% (w/v) solution of titan ium(IV)isopropoxide in n-butanol. The flask was purged 2× with nitrogen and immersed in a Belmont metal bath at 200° C. for 60 minutes and 220° C. for an additional 60 minutes under a slow nitrogen sweep with agitation. After increasing the temperature to 260° C., a vacuum of 0.3 mm was attained and held for 22 minutes to complete the polycondensation. The vacuum was displaced with nitrogen and the clear, amber polymer melt was allowed to cool before removal from the flask. An inherent viscosity of 0.80 was obtained for the recovered polymer according to ASTM D3835-79 at a concentration of 0.5 g/100 mL solvent. NMR analysis indicated that the actual glycol composition was 76 mole % diCHDM, and 24 mole % EG. Thermal analysis by DSC yielded a 2^{nd} cycle glass transition temperature (T_{g}) of 68° C.

### Example 6

### Describes a Low T_{g}, Non-Aromatic Copolyester Containing diCHDM

6. Cycloaliphatic-Based Copolyester Containing diCHDM

The apparatus described in Example 1 was charged with 100 grams (0.50 moles) dimethyl-1,4-cyclohexanedicarboxylate (DMCD), 53 grams (0.5 moles) diethylene glycol, 108 grams (0.40 moles) diCHDM, and 1.43 mL of a 0.98% (w/v) solution of titan ium(IV)isopropoxide in n-butanol. The flask was purged 2× with nitrogen and immersed in a Belmont metal bath at 200° C. for 60 minutes and 220° C. for an additional 95 minutes under a slow nitrogen sweep with agitation. After increasing the temperature to 260° C., a vacuum of 0.3 mm was attained and held for 22 minutes to complete the polycondensation. The vacuum was displaced with nitrogen and the clear, yellow polymer melt was allowed to cool before removal from the flask. An inherent viscosity of 0.75 was obtained for the recovered polymer according to ASTM D3835-79 at a concentration of 0.5 g/100 mL solvent. Thermal analysis by DSC yielded a 2^{nd} cycle glass transition temperature (T_{g}) of 23° C. and a 1^{st} cycle melting point (Tm) of 145° C.

### Example 7

### Shows how a Water-Dispersible Copolyester can be Obtained Containing diCHDM

7. Water-Dispersible Sulfopolyester Containing diCHDM

The apparatus described in Example 1 was charged with 47 grams (0.445 moles) isophthalic acid, 13 grams (0.1 moles) 5-sodiosulfoisophthalic acid, 64 grams (0.60 moles) DEG, 41 grams (0.15 moles) diCHDM, and 1.13 mL of a 0.98% (w/v) solution of titan ium(IV)isopropoxide in n-butanol. The flask was purged 2× with nitrogen and immersed in a Belmont metal bath at 220° C. for 160 minutes under a slow nitrogen sweep with agitation. After increasing the temperature to 250° C., a vacuum of 0.3 mm was attained and held for 22 minutes to complete the polycondensation. The vacuum was displaced with nitrogen and the slightly hazy, yellow polymer melt was allowed to cool before removal from the flask. An inherent viscosity of 0.39 was obtained for the recovered polymer according to ASTM D3835-79 at a concentration of 0.5 g/100 mL solvent. NMR analysis indicated that the actual sulfonate (5-SSIPA) was 10.5 mole %. Thermal analysis by DSC yielded a 2^{nd} cycle glass transition temperature (T_{g}) of 33° C. A dispersion was made by heating 25 grams of the sulfopolyester in 75 grams of deionized water at 80-90° C. for 2 hours. The viscous, opaque white dispersion was cooled to room temperature and did not show any precipitate after several weeks of observation.

The invention has been described in detail with particular reference to preferred embodiments thereof, but it will be understood that variations and modifications can be effected within the spirit and scope of the invention.

We claim:

1. A polymer comprising residues of at least one dicarboxylic acid and from about 0.5 mole % to about 100 mole % diCHDM residues, wherein the final polymer comprises substantially equal molar proportions of acid equivalents (100 mole %) and diol equivalents (100 mole %) for a total of 200 mole % for all reactants.
